(19) United States
(12) Patent Application Publication
(10) Pub. No.: US 2026/0331409 A1
(43) Pub. Date: Oct. 22, 2026

(54) CIRCUIT BREAKER MODULE

(71) Applicant: Ellenberger & Poensgen GmbH, Altdorf (DE)

(72) Inventors: Thomas REGAHL, Lauf an der Pegnitz (DE); Herbert ROTH, Altdorf (DE); Tobias PREM, Neumarkt (DE); Maximilian WERNER, Hannover (DE)

(73) Assignee: Ellenberger & Poensgen GmbH, Altdorf (DE)

(21) Appl. No.: 19/700,649

(22) Filed: Jun. 8, 2026

Related U.S. Application Data
(63) Continuation of application No. PCT/EP2024/080144, filed on Oct. 24, 2024.

(30) Foreign Application Priority Data
Dec. 8, 2023 (DE) 10 2023 212 427.0

(51) Int. Cl. H01H 85/20; H01H 85/02

(52) U.S. Cl. CPC H01H 85/20; H01H 85/0241; H01H 2085/2085

(57) ABSTRACT

A circuit breaker module having a housing in which a circuit breaker is located. A fuse is electrically connected in series to the circuit breaker module and is arranged in an opening in the housing. An assembly is also provided.

This nonprovisional application is a continuation of International Application No. PCT/EP2024/080144, which was filed on Oct. 24, 2024, and which claims priority to German Patent Application No. 10 2023 212 427.0, which was filed in Germany on Dec. 8, 2023, and which are both herein incorporated by reference.

### BACKGROUND OF THE INVENTION

### Field of the Invention

The invention relates to a circuit breaker module having a housing in which a circuit breaker is located. The invention also relates to an assembly having a circuit breaker module.

### Description of the Background Art

Installations, such as industrial installations, customarily have one or more actuators by means of which an activity is carried out. In the case of an industrial installation, for example, creation and/or processing of a workpiece is carried out by means of the actuator. An electrical line is used to supply power in this case. Generally, the installation includes multiple such actuators, and, for simplified installation, all electrical lines are routed into a distribution cabinet in which all electrical lines make electrical contact with a main line. In the event of a fault condition, such as an overcurrent or a short circuit, it is necessary to stop the supply of power to the actuator in order to prevent damage to the actuator or to the electrical line used for supplying power. The actuator is also reliably shut down in this way so that it poses no hazard to the environment, as well.

To interrupt the supply of power, a fuse, such as a glass-tube fuse, for example, is used that is electrically connected in series with the respective electrical line. When a specific level of the electric current is exceeded for a specific period of time that is specified by means of a characteristic curve of the fuse, a part of the fuse melts so that the flow of current is interrupted. It is an advantage thereof that a susceptibility to faults is relatively low. It is a disadvantage thereof that a subsequent modification of the characteristic curve specified at manufacture is not possible. In addition, the fuse is damaged after triggering thereof so that a replacement of the fuse is necessary in order to place the actuator back in service. Furthermore, diagnosis, for example of when or why the flow of electric current was interrupted, and monitoring of the current state of the fuse are not possible.

For this reason, preferably a circuit breaker is used for interrupting that has a switching element that, for example, is mechanical or electrical in design and thus includes a relay or a semiconductor switch. Actuation of the switching element is accomplished by means of, e.g., a latch or a controller by means of which an electric current that is currently being carried by the circuit breaker is measured and/or a voltage that is present is monitored. On account of such a design, dynamic adaptation to different installation situations is possible, even during operation. Furthermore, no damage to the circuit breaker is present after the interruption of the flow of electric current, so the circuit breaker can be placed back in service. With an appropriate design of the circuit breaker, it is also possible to place it in the electrically conductive state by means of the controller so that manual actuation is not necessary. Typically the circuit breakers are located in the distribution cabinet and each (electrical) line is associated with one of the circuit breakers.

In order for the distribution cabinet to be used on the American and

Canadian markets, it is necessary for it to meet the prevailing requirements there such as, e.g., UL 508A. For this purpose, it is necessary for either a so-called “branch circuit breaker” approved under UL 489 or a Class CC fuse under UL 248-4 to be associated with each line. So that flexible adaptation is made possible here as well, a circuit breaker is associated with at least a part of every line so that additional protection is present. The triggering characteristic of each circuit breaker is chosen as a function of the respective associated fuse in this case so that the fuse serves merely as a fallback in case the circuit breaker has a malfunction. The advantage of such a design is that the requirement of UL 508A is fulfilled as long as the circuit breaker fulfills UL certification. In this case, relatively high flexibility in the protection of the actuator is present, wherein monitoring of the switching state of the circuit breaker, and if applicable also a remote resetting of the circuit breaker, are made possible. However, a disadvantage hereof is the increased space requirement in the distribution cabinet and relatively great effort for installation, in particular for the cabling thereof, as well as for any reconfiguration.

### SUMMARY OF THE INVENTION

It is therefore an object of the present invention to provide an especially suitable circuit breaker module as well as an especially suitable assembly, wherein installation advantageously is simplified, and wherein safety is increased, in particular.

In the installed state, the circuit breaker module is a component part of an installation by means of which a specific function is carried out, for example. The circuit breaker module preferably is suitable, and expediently is provided and configured, for this purpose. In particular, the installation is an industrial installation and serves to produce and/or process a particular workpiece, for example. For this purpose, the installation has an actuator, in particular. The actuator is, e.g., an electric motor that is a rotating electric motor or a linear motor, for example. Expediently, the electric motor is a stepper motor. Alternatively thereto, the actuator is a valve that is electrically actuated, for example. In another alternative, the installation is a communications system or a computing center, for example.

The circuit breaker module in this case is suitable, in particular, is intended and equipped to interrupt or to establish a flow of electric current. In this case, the electric current that is carried in the normal case and, in particular, corresponds to the rated current, is preferably between 0.5 A and 200 A, between 1 A and 100 A, or between 10 A and 50 A. Preferably, a rated voltage of the circuit breaker module, which, in particular, is applied thereto when the circuit breaker module is not electrically conductive is between 12 V and 60 V and, for example, is equal to 12 V, 24 V, 36 V, or 48 V. In particular, the voltage is a DC voltage.

The circuit breaker module has a circuit breaker. The circuit breaker serves as protection against a fault condition, in particular an overcurrent, a fault current, or a short-circuit current. The circuit breaker is suitable, in particular is intended and equipped, for this purpose. In summary, the circuit breaker serves as protection against a fault condition. The circuit breaker in this case is preferably a miniature circuit breaker, which is also referred to as an automatic circuit breaker. Alternatively thereto, the circuit breaker is an equipment circuit breaker.

The circuit breaker can have a switching element through which, in the normal case, electric current expediently is carried that suitably is used for supplying power to an actuator that is electrically connected to the circuit breaker module. For example, the circuit breaker is mechanical or electrical in design. Alternatively thereto, the circuit breaker is formed from a combination thereof. For example, the switching element is a relay or a semiconductor switch. In particular, the circuit breaker has multiple such switching elements, which are electrically connected in series and/or in parallel, for example.

Expediently, the circuit breaker can have a control unit by means of which the switching element or elements is/are actuated, in particular as a function of an event such as the fault condition. Expediently, the circuit breaker includes one or more sensors by means of which the electric current that is carried by the circuit breaker and/or the voltage that is present is/are sensed. Expediently, the sensor is connected to the possible control unit by a signal.

For example, the control unit can have a data input or the like by means of which an actuation of the switching element is likewise made possible. In the installed state, the data input is connected by a signal to a higher-level controller, in particular. Alternatively or in combination herewith, a querying of a switching state of the switching element and/or a resetting/closing of the switching element is made possible by means of the data input.

In particular, the circuit breaker module can have one or more connections to which an electrical line or the like is connected in the installed state. For example, at least one of the connections is designed in the manner of a terminal. The circuit breaker in this case is electrically connected between the two connections, and an electric current is carried between the connections when the circuit breaker is electrically conductive.

In particular, the circuit breaker, and thus also the circuit breaker module, can serve to protect a device and/or an electrical line that is connected to one of the possible connections, in particular. In this case, a triggering characteristic/characteristic curve of the circuit breaker, which is to say when the latter is actuated/opened, preferably is adapted to the application.

The circuit breaker can be located in a housing of the circuit breaker module. The housing preferably is made of a plastic so that an electrical insulation of the components located within the housing, such as, in particular, the circuit breaker, is realized. Also, shock-hazard protection is provided in this way. Expediently, the housing has one or more contact openings through which electrical contact with the components located inside the housing is made possible. Preferably, one of the contact openings is associated with the possible connection in this case. In particular, one of the contact openings is associated with the possible data input of the control unit.

The circuit breaker module additionally can have a fuse that is electrically connected in series with the circuit breaker. Consequently, the electric current is also carried through the fuse during operation of the circuit breaker module. The fuse serves as an additional safety element, in particular as a fallback, if the circuit breaker has a malfunction. In particular, a triggering characteristic/characteristic curve of the fuse in this case is such that the circuit breaker is actuated first. In other words, in the event of a fault condition, the circuit breaker is always actuated first before destruction of the fuse would take place. In particular, a triggering of the fuse therefore only takes place when the circuit breaker is damaged/has a fault. Expediently, the fuse is designed as a glass-tube fuse. The fuse is located in an opening in the housing. In particular, the fuse in this case is in the interior of the housing, and is accessible through the opening. Preferably, the opening has a larger dimension than the fuse so that the latter is located in the opening. In other words, the opening covers the fuse located in the housing so that the fuse is located in the opening.

Safety is increased on account of the fuse electrically connected in series and the circuit breaker, and if there is a failure of the circuit breaker, the flow of current is interrupted by means of the fuse so that safety is increased. In this case, the fuse and the circuit breaker are located in the same housing so that they, namely the circuit breaker module, are installed in a single step, in particular in a distribution cabinet. Consequently, installation is simplified. Also, faulty installation, for example faulty cabling, is precluded in this way, further simplifying installation. Moreover, it is ensured in this way that the fuse is matched to the circuit breaker, which further simplifies design of an interconnection with other components and/or reconfiguration. Since the fuse is located in the opening, replacement of the fuse is possible and, moreover, is relatively simple, so that operation of the circuit breaker is also simplified.

Expediently, the fuse fulfills the requirements of UL 248-4 so the circuit breaker module can also be used on the American and/or Canadian markets, at least in some cases.

For example, the opening can be placed in a front of the housing so that it is essentially always accessible, which simplifies maintenance. Preferably, the housing is suitable, in particular intended and equipped, for installation on a mounting rail and/or top-hat rail. For example, only one circuit breaker is present. Especially preferably, however, the circuit breaker module includes two or more such circuit breakers, which are identical in design to one another, for example. Each circuit breaker is electrically connected in series with the fuse in this case, so that both circuit breakers are protected by it. The circuit breakers preferably are electrically connected in parallel with one another. Consequently, each of the circuit breakers can protect one actuator. Expediently, the housing has a number of connections corresponding to the number of circuit breakers.

For example, the fuse can be connected to a cable by means of an attachment. Especially preferably, however, the fuse is inserted into a fuse holder so that the fuse is stabilized by means of the fuse holder. For example, the fuse holder is attached to the housing. Especially preferably, however, the circuit breaker has a printed circuit board to which the fuse holder is attached. In particular, the fuse holder electrically makes electrical contact with conductive traces of the printed circuit board in this case. On account of the printed circuit board as well as the fuse holder, a robustness of the circuit breaker module is increased and manufacture is made easier. Preferably, electrical and/or electronic components are attached to the printed circuit board and expediently are suitably connected to one another. Expediently, component parts of the circuit breaker are fastened to the printed circuit board and are suitably connected by means thereof to one another and/or to the fuse holder. Consequently, construction is further simplified.

In particular, the fuse holder can have multiple spring elements by means of which the fuse is at least partially gripped in the installed state so that the position of the fuse is stabilized. Suitably, an electrical contact of the fuse is additionally accomplished by means of the fuse holder, preferably the spring elements. Preferably, the fuse holder fulfills the requirements of UL 4248. In this context, the fuse suitably fulfills the requirements of UL 248-4, and therefore the UL 508A specification is fulfilled by the circuit breaker module. Consequently, there are only few requirements on the design of the circuit breaker, and it can be adapted to the relevant application, which increases safety and convenience. In this case, the circuit breaker module also continues to fulfill the UL 508A specification and can therefore be used on the American and Canadian markets.

The fuse preferably has a longitudinal direction, which is to say, in particular, a direction along which the fuse has its greatest dimension. For example, in this case the fuse is symmetrical with respect to a longitudinal axis that is parallel to the longitudinal direction. If the fuse is essentially cylindrical, then the longitudinal axis corresponds to the axis of the cylinder. In other words, the fuse has the longitudinal axis that is parallel to the longitudinal direction, and the longitudinal direction is therefore associated with the fuse.

For example, inserted into the opening is a mechanism by means of which the fuse can be removed from the opening. In this case, the direction of insertion of the fuse is parallel to the longitudinal direction of the fuse, in particular. On account of such an arrangement, the opening is relatively small so that an ingress of foreign particles into the housing is reduced. Preferably, however, the direction of insertion into the opening is perpendicular to the longitudinal direction. In other words, to insert the fuse into the opening, it is moved perpendicular to its longitudinal direction. Expediently, in this case the fuse holder is present and/or after the insertion of the fuse into the opening, the orientation thereof is no longer changed. Expediently, the (dimension of the) opening is greater than the dimension of the fuse in the longitudinal direction, and the opening covers the fuse. Consequently, an insertion of the fuse into the housing, in particular into the fuse holder, as well as the removal therefrom, without a tool is made possible, and therefore operation of the circuit breaker module is simplified. Also, no additional mechanism is required, and therefore manufacturing costs are reduced and construction is simplified. Also, susceptibility to faults is reduced.

For example, in the installed state the opening can be closed by a cover. Especially preferably, however, the housing is without a cover so that the opening is not closed by additional component parts of the circuit breaker module. Consequently, manufacture is simplified and manufacturing costs are reduced.

Preferably, the housing can be laterally stackable, and the circuit breaker module is thus a stackable device. In other words, in the installed state an additional stackable device is located laterally next to the circuit breaker module and they are at least partially flush with one another, in particular. Preferably, in this case the circuit breaker module and the possible additional stackable devices are suitable, in particular intended and equipped, for installation of a top-hat rail.

Especially preferably, the opening can be placed in one of the lateral surfaces of the housing in this case. In the installed state, an additional stackable device, if it is present, preferably adjoins this lateral surface in this case. Consequently, the opening is closed by means of the other device in the installed state so that an ingress of foreign particles there is prevented. Removing the circuit breaker module from the combination with the additional stackable device, which together preferably at least partially form an assembly, makes the opening accessible again so that replacement of the fuse is made possible.

For example, no additional function is associated with the lateral surface in this case. Suitably, however, a contact element for connection to an adjacent stackable device, preferably the additional stackable device, is associated with the lateral surface that has the opening. In the installed state, which is to say when the circuit breaker module is used, the contact with the other stackable device consequently is made through these lateral surfaces. If, therefore, the circuit breaker module is to be used, the stackable device through which the electrical contact is made with the circuit breaker module is always located on this lateral surface. Therefore, the opening is always closed by the stackable device when the circuit breaker module is used so that an ingress of foreign particles is prevented. In this case, no additional cover is necessary, which reduces weight and manufacturing costs. Here, the opening can also be designed to be relatively large, which facilitates insertion of the fuse.

Transmission of an electric potential between the circuit breaker module and the adjacent stackable device, in particular, is accomplished by means of the contact element. In particular, an electric current that is protected by means of the circuit breaker module, for example, is carried by the contact element during operation. Alternatively or in combination therewith, the contact element serves the purpose of connecting by a signal to the adjacent stackable device and, in particular, a bus system or the like is realized in this way.

For example, the contact element can be a plug connector that is located adjacent to the opening. Especially preferably, however, the contact element is a pivoting lever that is mounted on the housing. In this case, the pivoting lever expediently projects at least partially beyond the lateral surface so that, when it is pivoted, it mates with corresponding elements of the adjacent stackable device, thus preventing the stackable device from being spaced apart from the circuit breaker module. Preferably, the pivoting lever has multiple contact pins that are made of metal, in particular. Preferably, the contact pins are attached to a body of the pivoting lever that, in particular, is made of a plastic. Consequently, electrical contact of the contact pins with one another is accomplished by means of the body, and therefore a short circuit is avoided. In particular, at least some of the contact pins are associated with the adjacent stackable device when the latter is installed, and these pins make electrical contact therewith. The contact pins are suitable, in particular intended and equipped, for this purpose.

For example, the contact pins can be electrically connected to the circuit breaker by means of one cable each, or at least the cables are routed into the interior of the housing. Especially preferably, however, the housing has multiple contact openings, and the lever is designed such that, when it is pivoted, one of the contact pins is inserted into each of the contact openings. In particular, the circuit breaker module has multiple contact points located inside the housing, against each of which one of the contact pins rests and thereby makes electrical contact therewith. In other words, a corresponding contact point is associated with each of the contact openings. In particular, they are located on and/or attached to the possible printed circuit board, which simplifies construction.

Preferably, more contact pins can be present than contact openings, preferably twice as many contact pins as contact openings. In this case, each contact pin that is inserted into one of the contact openings of the circuit breaker module is electrically connected to another of the contact pins, which preferably is outside the housing. Expediently, the pairs of contact pins thus formed are formed by means of one common electrical conductor in each case, which is shaped in the manner of a clip, for example.

In the installed state, the contact pins located outside the housing of the circuit breaker module can each be enclosed in an additional contact opening of an adjacently located stackable device. Consequently, the circuit breaker module and the stackable device are stabilized with respect to one another by means of the contact pins, which increases robustness.

The assembly can have a circuit breaker module that includes a housing in which a circuit breaker is located. Furthermore, the circuit breaker module has a fuse that is electrically connected in series with the circuit breaker and is located in an opening of the housing. The housing is laterally stackable. Furthermore, the assembly includes a stackable device that is located adjacent to the circuit breaker module. The circuit breaker module and/or the stackable device preferably are suitable, in particular intended and equipped, for installation on a mounting rail and/or top-hat rail. Preferably, the assembly includes the mounting rail/top-hat rail to which the circuit breaker module and the stackable device are attached.

The opening can be placed in one of the lateral surfaces of the housing with which is also associated a contact element of the circuit breaker module for connection to the adjacent stackable device. In this case, the adjacent stackable device adjoins this lateral surface, and the opening is covered by means of the same so that the fuse is not visible and is protected from foreign particles. Also, electrical insulation of the fuse is realized in this way.

The contact element in this case can be a pivoting lever that is mounted on the housing and has multiple contact pins. The housing has multiple contact openings, wherein the pivoting lever is designed such that, when it is pivoted, one of the contact pins is inserted into each of the contact openings. In the installed state, the pivoting lever is arranged such that one of the contact pins in each case is enclosed in the respective associated contact opening.

The stackable device can have multiple additional contact openings, wherein the number of additional contact openings expediently is equal to the number of contact openings. In the installed state, one of the contact pins is enclosed in each of the additional contact openings, and each contact pin that is enclosed in one of the contact openings is electrically connected to one of the contact pins that is enclosed in one of the additional contact openings. In particular, these contact pins are each formed by means of a common conductor, in particular a metallic clip. Consequently, electrical contact of the circuit breaker module with the adjacently located stackable device is accomplished by means of the contact element, wherein no cables or the like are needed for this purpose. Expediently, operation of a mechanical locking mechanism is additionally accomplished here by means of the pivoting lever, by means of which the circuit breaker module is locked to the possible top-hat rail/mounting rail.

The adjacently located stackable device, which in particular is also referred to simply as stackable device, adjacent device, or device, is, for example, likewise a circuit breaker module that expediently is identical in design. Alternatively, the device is, for example, a communication unit or a distribution unit.

The improvements and advantages explained in connection with the circuit breaker module can also be applied correspondingly to the assembly and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an assembly with a circuit breaker module in a perspective view,

FIG. 2 schematically shows the circuit breaker module in a sectional view,

FIGS. 3 and 4 show the circuit breaker module that has a housing, in a perspective view and in a side view, respectively,

FIG. 5 shows the circuit breaker module in a side view, wherein a part of the housing is not shown, and

FIG. 6 shows a fuse inserted in a fuse holder, in a perspective view.

### DETAILED DESCRIPTION

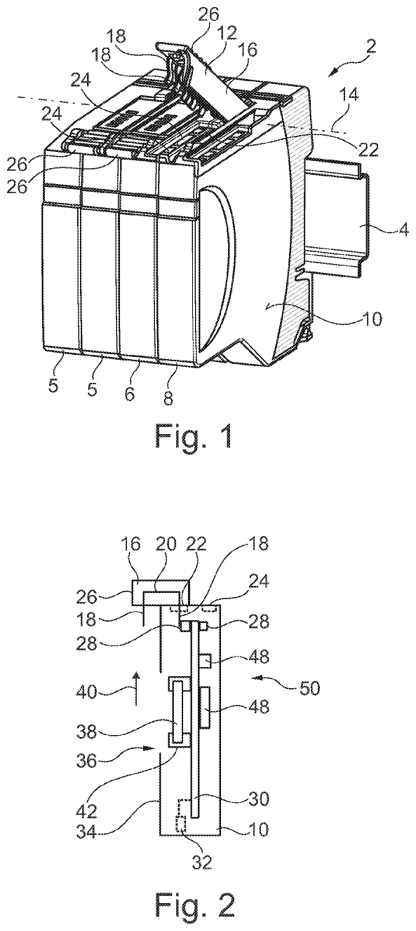

Depicted in a perspective view in FIG. 1 is an assembly 2 that has a mounting rail 4 designed in the manner of a top-hat rail. The assembly 2 is located in a distribution cabinet that is not shown in detail, and serves to supply an actuator of an industrial installation. The actuator includes an electric motor that is operated with a DC voltage of 12 V, which is supplied by means of the assembly 2.

Attached to the mounting rail 4 are two stackable devices 5, which are located side by side. One of the two stackable devices 5 is a distribution unit that is connected to a main line that extends into the distribution cabinet and by which means 12 V is carried. The other stackable device 5 is a communication unit. Also attached to the mounting rail 4 is an adjacent stackable device 6, which likewise is designed as a communication unit and which is located next to the other communication unit. In this case, the two communication units are identical in design to one another.

Located next to the adjacent stackable device 6 is a circuit breaker module 8, which likewise is attached to the mounting rail 4. The circuit breaker module 8 has a housing 10 whose outline perpendicular to the path of the mounting rail 4 is the same as the outline of the stackable devices 5 as well as that of adjacent stackable device 6. In this case, the circuit breaker module 8, the adjacent stackable device 6, and the stackable devices 5 are arranged flush with one another.

A pivoting lever 12 is mounted on the housing 10 so as to be rotatable about a pivot axis 14 that is parallel to the mounting rail 4. The pivoting lever 12 has a body 16 that is made of a plastic, and to which multiple contact pins 18 are fastened, as is shown in FIG. 2 in a sectional view of the circuit breaker module 8 parallel to the pivot axis 14. Two of the contact pins 18 in each case are formed by means of a common conductor 20 that is provided by means of a metallic clip.

In the installed state, when the pivoting lever 12 rests flat against the housing 10, one of the contact pins 18 of the same conductor 20 is inserted in each case into a contact opening 22 of the housing 10. In summary, the pivoting lever 12 mounted on the housing 10 has the contact pins 18, wherein the pivoting lever 12 is designed such that, when it is pivoted, one of the contact pins 18 is inserted into each of the contact openings 22 of the housing 10.

Each of the remaining contact pins 18 of the relevant same conductor 20 is then enclosed in one of the additional contact openings 24 of the adjacent stackable device 6 that are placed in a corresponding housing of the stackable device 6. Different electric potentials are carried in this case by means of the different conductors 20 of the pivoting lever 12, and the pivoting lever 12 forms a contact element 26 for electrical connection and also connection by a signal to the adjacent stackable device 6.

A corresponding contact element 26 is also associated with the adjacent stackable device 6 and one of the stackable devices 5, namely the communication unit, so that the two communication units are connected to one another by a signal and electrically and the two stackable devices 5 are connected to one another by a signal and electrically. For this purpose, the stackable devices 5 as well as the adjacent stackable device 6 also have corresponding contact openings 22 as well as additional contact openings 24. In summary, all stackable devices 5, the adjacent stackable device 6, and the circuit breaker module 8 are connected to one another both electrically and by a signal, wherein a bus system is formed by means of the connection by a signal.

Each of the contact pins 18 within the or routed through the contact openings 22 of the housing 10 rests against a contact point 28 in each case, which is provided by means of a socket fastened to a printed circuit board 30 located in the housing. One of the contact points 28 in each case is associated with each contact opening 22 here, and the printed circuit board 30 is perpendicular to the path of the mounting rail 4.

An additional contact openings 24 in each case is likewise placed adjacent to each contact opening 22 in the housing 10 so that the circuit breaker module 8 can also make electrical contact with an additional stackable device (not shown) by means of its associated contact element 26. A contact point 28 is also associated with each of the additional contact openings 24, although these contact points are located on the opposite side of the printed circuit board 30.

The printed circuit board 30 makes electrical contact with a connection 32, which is placed in the housing 10 so that the printed circuit board 30 can be contacted from outside the housing 10 by means of the connection 32. In the installed state, the electrical line leading to the associated actuator is connected to the connection 32.

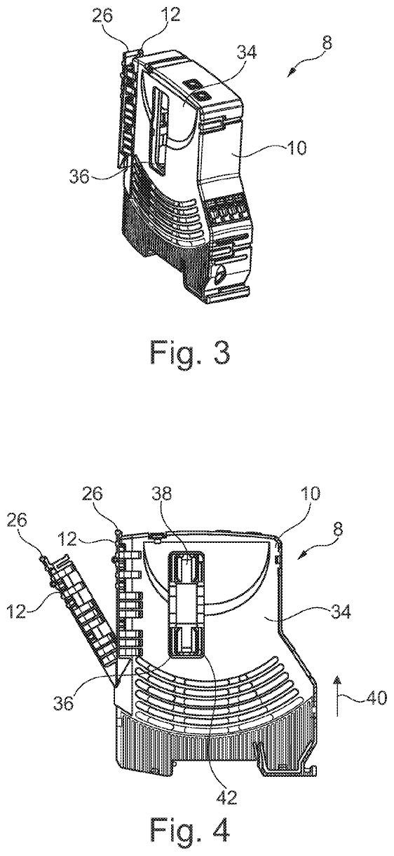

As is also shown in FIG. 3 in a perspective view of the circuit breaker module 8 and in FIG. 4 in a side view in which the contact element 26, which is to say the pivoting lever 12, is shown in a different position, an opening 36 is placed in the lateral surface 34 of the housing 10 that adjoins a corresponding lateral wall of the adjacent stackable device 6. Consequently, the opening 36, which is rectangular, is placed in the lateral surface 34 with which the contact element 26 for connection to the adjacent stackable device 6 is associated.

Located within the opening 36 is a fuse 38, which is a glass-tube fuse, and which fulfills UL248-4 certification. In this case, the area of the opening 36 is larger than the area (projection) of the fuse 38, and the opening 36 completely covers the fuse 38. The fuse 38 is cylindrical in design and has a longitudinal direction that is parallel to the axis of the cylinder. The longitudinal direction 40 is parallel to the lateral surface 34 in this case. For insertion, the fuse 38 is moved relative to its longitudinal direction 40 into the opening 36 so that the direction of insertion is perpendicular to the longitudinal direction 40.

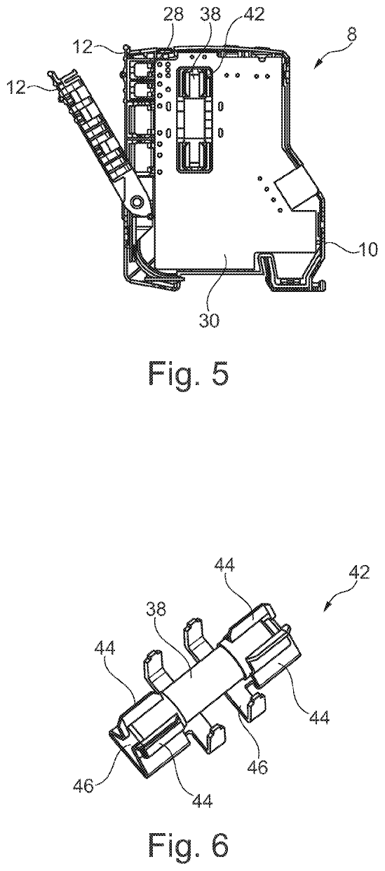

The fuse 38 is inserted into a fuse holder 42 and is detachably fastened thereto and makes electrical contact therewith. The fuse holder 42 fulfills UL 4248 certification. As is shown in FIG. 5, in which the circuit breaker module 8 is shown in a side view, but wherein the lateral surface 34 has been omitted, the fuse holder 42 is attached to the printed circuit board 30 and makes electrical contact therewith.

The fuse holder 42, which is shown in a perspective view in FIG. 6, has multiple spring elements 44 by means of which the fuse 38 is gripped. Half of the spring elements 44 in each case are attached to a relevant associated base plate 46. The two base plates 46 and the respective associated spring elements 44 are electrically insulated from one another in this case and are electrically connected solely by means of the fuse 38. Also, they are each designed as stamped and formed parts, and the base plates 46 are soldered to the printed circuit board 30.

Attached to the printed circuit board 30, furthermore, are multiple electrical and/or electronic components 48, a circuit breaker 50 being formed by means of said components as well as the interconnection through the printed circuit board 30. The circuit breaker has a switching element that is provided by means of one of the components 48 and is, for example, a relay or semiconductor switch. Also a control unit as well as a sensor of the circuit breaker 50 are provided by means of at least one of the components 48.

The circuit breaker 50 is electrically connected in series with the fuse 38, wherein the series connection is wired between the connection 32 and one of the contact points 28. If an excessive electric current, for example an overcurrent or a short-circuit current, is carried between this contact point 28 and the connection 32, the circuit breaker 50 triggers first so that the flow of electric current is interrupted. Only if the circuit breaker 50 has a malfunction does the fuse 38 trigger, and its characteristic curve is chosen accordingly. UL 508A certification is realized here on account of the fuse 38 and the fuse holder 42, wherein the design of the circuit breaker 50 can be relatively arbitrary. Consequently, a customizability of the circuit breaker module 8 is increased, wherein the installation on the mounting rail 4 takes place in one step. In this case, faulty cabling is essentially precluded, thus increasing safety.

The invention is not limited to the exemplary embodiment described above. Instead, other variants of the invention can also be derived herefrom by the person skilled in the art without departing from the subject matter of the invention. Moreover, all individual features described in connection with the individual exemplary embodiment can, in particular, also be combined with one another in other ways without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit breaker module comprising:
a housing in which a circuit breaker is arranged; and
a fuse that is electrically connected in series with the circuit breaker, the fuse being arranged an opening in the housing.

2. The circuit breaker module according to claim 1, wherein the circuit breaker has a printed circuit board to which is attached a fuse holder into which the fuse is inserted.

3. The circuit breaker module according to claim 1, wherein the fuse has a longitudinal direction, and wherein the direction of insertion into the opening is perpendicular to the longitudinal direction.

4. The circuit breaker module according to claim 1, wherein the housing is laterally stackable, and wherein the opening is placed in one of the lateral surfaces of the housing.

5. The circuit breaker module according to claim 4, wherein a contact element for connection to an adjacent stackable device is associated with the lateral surface.

6. The circuit breaker module according to claim 5, wherein the contact element is a pivoting lever that is mounted on the housing and has at least two contact pins.

7. The circuit breaker module according to claim 6, wherein the housing has at least two contact openings, and wherein the pivoting lever is designed such that, when it is pivoted, one of the contact pins is inserted into each of the contact openings.

8. An assembly comprising:
the circuit breaker module according to claim 7; and
an adjacently located stackable device that has at least two additional contact openings in which one of the contact pins is enclosed in each case,
wherein each contact pin that is enclosed in one of the contact openings is electrically connected in each case to one of the contact pins that is enclosed in one of the additional contact openings.
